(19) United States
(12) Patent Application Publication
(10) Pub. No.: US 2006/0159260 A1
(43) Pub. Date: Jul. 20, 2006

(54) Method and communication system employing secure key exchange for encoding and decoding messages between nodes of a communication network

(75) Inventors: Luis R. Pereira, Milwaukee, WI (US); Kamalavasan Srinivasan, Madison, WI (US)

Correspondence Address: MARTIN J. MORAN, ESQ.;Eaton Electrical, Inc., Technology & Quality Center, 170 Industry Drive, RIDC Park West, Pittsburgh, PA, 15275-1032, US

(73) Assignee: EATON CORPORATION

(21) Appl. No.: 11/035,898

(22) Filed: Jan. 14, 2005

(51) Int. Cl. H04L 9/00

(52) U.S. Cl. 380/44

(57) ABSTRACT

A method encodes and decodes messages between nodes of a wireless communication network. A first node, such as a fob, is mated with a second node, such as a base station, of the wireless communication network. A time duration of the mating is determined in the fob. The time duration of the mating is also determined in the base station. An encryption key is generated based upon the time duration in the fob. The encryption key is also generated based upon the time duration in the base station. Subsequently, communication messages over the wireless communication network are encrypted and decrypted between the fob and the base station employing the encryption key.

### BACKGROUND OF THE INVENTION

1. Field of the Invention

This invention pertains generally to communication systems and, more particularly, to communication systems including communicating nodes, which encode and decode communication messages therebetween. The invention also pertains to a method for encoding and decoding communication messages between nodes of a communication network.

2. Background Information

A simple key exchange often proves to be a dominant obstacle in security implementation for wireless sensor networks. This issue is magnified by the fact that low-cost embedded nodes of such wireless sensor networks are limited in resources.

The problem of key exchange has been addressed efficiently in conventional computer networks. However, the reuse of mechanisms applied in conventional computer networks to wireless sensor networks is not believed to be feasible due to the relatively extreme limitations in resources available for computation and transmission, thereby ruling out a conventional key exchange through an asymmetric mechanism.

In a system employing a plurality of sensors of a wireless sensor network monitored by a base station, there is the need for simplicity of the system from the user's perspective. In other words, the system should have very minimal user intervention for operating in a secure mode. In addition to this need, an efficient encryption mechanism is not enough for securing the network against masquerade attacks, denial of service attacks and replay attacks.

The process of distinguishing a message in such a way as to hide its substance is encryption, which process turns plaintext (or cleartext) into ciphertext. Conversely, the process of decryption turns ciphertext back into plaintext (or cleartext). Encryption and decryption may also be referred to as to encipher and decipher, respectively. See, for example, ISO 682-2: 1989, Information processing systems—Open Systems Interconnection—Basic Reference Model—Part 2: Security architecture.

A cryptographic algorithm or cipher is a general mathematical function employed for encryption and decryption, with one function being employed for encryption and a second related function being employed for decryption. Both of these functions employ one or more keys, with the security in these functions being based upon the encryption keys rather than the specific functions. Hence, in some instances, the encryption keys are kept secret or private in order to prevent unauthorized parties from reading the message.

A block cipher transforms a fixed-length block of plaintext into a block of ciphertext of the same length. The block cipher employs a user-provided secret key to provide both encryption and decryption. For example, in some instances, the size of the fixed-length block or block size is 64 bits.

An iterated block cipher encrypts a plaintext block by a process that has a plurality of rounds. In each round, the same transformation or round function is applied to the data using a subkey. Typically, the set of subkeys is derived from the user-provided secret key by a suitable key schedule. The number of rounds in an iterated block cipher depends upon the desired security level and the desired execution time or performance. Typically, increasing the number of rounds improves security, but at the expense of performance.

Feistel ciphers or DES-like ciphers are a special class of iterated block ciphers wherein ciphertext is calculated from plaintext by repeated application of the same transformation or round function. In a Feistel cipher, the text being encrypted is split into two halves. A round function, ƒ, is applied to one half using a subkey and the output of that round function, ƒ, is XORed with the other half. The two halves are then swapped. Each round follows the same pattern except for the last round where there is no swap. In the Feistel cipher, encryption and decryption are structurally identical, with the subkeys employed during encryption at each round being taken in reverse order during decryption.

It is possible to design iterative ciphers that are not Feistel ciphers, yet whose encryption and decryption, after a certain reordering or recalculation of variables, are structurally the same. One such example is IDEA.

The Data Encryption Standard (DES) is a symmetric encryption/decryption block cipher defined and endorsed by the United States government, in 1977, as an official standard. See Federal Information Processing Standards publication FIPS PUB 46. DES is well known, widely used and is still considered reasonably secure. The same secret key is employed, for example, by both a sender and a receiver to encrypt and decrypt a message, or to store a file on a hard disk in encrypted form. DES has a 64-bit block size, uses a 56-bit secret key during encryption, by means of permutation and substitution, and employs 16 rounds.

A Secure And Fast Encryption Routine (SAFER) is a non-proprietary block cipher, which employs slightly different encryption and decryption procedures, a 64-bit block size and, in one version, a 64-bit key size. SAFER employs a variable number of rounds, with a maximum of about ten rounds and a minimum of at least about six rounds. Only byte-based operations are employed in order to provide utility in smart card-based applications, which have limited processing power.

An Advanced Encryption Standard (AES) is a proposed unclassified, publicly disclosed, royalty-free encryption algorithm capable of protecting sensitive government information well into the next century. See Nechvatal, James, et al., Report on the Development of the Advanced Encryption Standard (AES), National Institute of Standards and Technology (Oct. 2, 2000). The National Institute of Standards and Technology has specified that the proposed algorithms must implement a symmetric block cipher, with a block size of 128 bits, and keys sizes of at least 128, 192 and 256 bits, with the algorithm having security at least as good as Triple-DES, but with significantly improved efficiency.

In a known cipher-block chaining (CBC) technique (“CBC mode”), an initialization vector of zero is applied to the data to be authenticated. The final block of the resulting CBC output, possibly truncated, serves as a message authentication code (MAC) of the data. CBC is very similar to a cipher feedback mode in which the whole block is fed back every time. Each block of the message is XORed with the previous ciphertext block and then is enciphered prior to communication. In other words, the ciphertext value of a preceding block is exclusive-OR combined with the plaintext value for the current block. This randomization has the effect of distributing the resulting block values evenly among all possible block values, and so tends to prevent codebook attacks. But ciphering the first block generally requires an initial value to start the process. The initial value necessarily expands the ciphertext by the size of the initial value.

Counter-mode encryption (“CTR mode”) was introduced by Diffie and Hellman in 1979 and is standardized by, for example, Section 6.4 of ATM Security Specification Version 1.0, af-sec-0100.001. See ftp://ftp.atmforum.com/pub/approved-specs/af-sec-0100.001.pdf.

CTR mode employs a notation, E_{K}(X) to denote the encipherment of an n-bit block X using key K and a block cipher E. For concreteness, this assumes that E=AES algorithm (Rijndael) or AES, so n=128. If X is a nonempty string and i is a nonnegative integer, then X+i denotes the |X|-bit string that one gets by regarding X as a nonnegative number (written in binary, most significant bit first), adding i to this number, taking the result modulo 2^{|X|}, and converting this number back into an |X|-bit string. This is the customary semantics for computer addition.

In operation, to encrypt using CTR-mode encryption, one starts with a plaintext M (an arbitrary bit string), an encryption key K, and a counter ctr, where ctr is an n-bit string. Let C be the XOR (excusive-or) of M and the first |M| bits of the pad E_{K}(ctr)∥∥E_{K}(ctr+1)∥∥E_{K}(ctr+2) . . . . The ciphertext is (ctr, C), or, more generally, C together with something adequate to recover ctr. To decrypt ciphertext (ctr, C) compute the plaintext M as the XOR of C and the first |C| bits of the pad E_{K}(ctr)∥∥E_{K}(ctr+1)∥∥E_{K}(ctr+2) . . . . Therefore, decryption is the same as encryption with M and C interchanged (see FIG. 1). Often, C itself, rather than (ctr, C), is referred to as the ciphertext.

In the recommended usage scenario, the party encrypting maintains an integer counter, nonce, initially 0, and produces the string ctr as the 128-bit string which encodes the number nonce 2⁶⁴. In other words, nonce is regarded as a 64-bit binary number, and ctr is constructed by appending to this number 64 zero-bits. The number nonce is incremented following each encryption. Typically, one transmits C along with a string which encodes nonce.

A well-designed standard for CTR mode should not be overly prescriptive about how ctr is formed or what beyond C is explicitly communicated between sender and receiver. To illustrate some possibilities: (1) the value ctr is derived from a nonce nonce by the method just described, and the ciphertext specifies both nonce and C; (2) the same, except that no nonce-value is explicitly transmitted to the receiver because the sender and the receiver maintain state and communicate over a reliable channel; (3) the same, except that nonce starts at a random value in [0 . . . 2⁶⁴⁻¹] instead of starting at 0; (4) ctr is a random 128-bit string, selected afresh with each message sent; and (5) ctr is determined implicitly by other protocol elements, such as an accompanying sequence number (e.g., in the context of IPSec).

The above scenarios make clear that no single method of producing ctr is the best in all situations. It is ultimately the user's responsibility to ensure that it is impossible, or highly improbable, that a ctr value is ever reused with the same key K.

There is room for improvement in communication systems and methods for encoding and decoding messages between nodes of a communication network.

### SUMMARY OF THE INVENTION

These needs and others are met by the present invention, which provides a method to solve the problem of secure encryption key exchange with minimal user intervention and which provides a simple method to generate such encryption key based upon a mating time, which is known only to a pair of nodes. This mechanism has a relatively very low communication and processing overhead. The symmetric encryption key, which may also employ a counter, effectively employs an out of band channel for encryption key exchange. For example, the user is preferably not aware that they mate one node with another node.

In accordance with one aspect of the invention, a method of encoding and decoding messages between nodes of a communication network comprises: mating a first node with a second node of the communication network; determining a time duration of the mating in the first node; determining the time duration of the mating in the second node; generating an encryption key based upon the time duration in the first node; generating the encryption key based upon the time duration in the second node; and encoding and decoding messages between the first and second nodes employing the encryption key.

The method may employ as the first node a fob, employ as the second node a base station, and mate the fob with the base station.

The method may further comprise employing as the encryption key a first encryption key; encoding a first message at the fob with the first encryption key; sending the first message from the fob to the base station; decoding the first message at the base station with the first encryption key; generating a second encryption key at the base station; encoding a second message including the second encryption key at the base station with the first encryption key; sending the second message including the second encryption key from the base station to the fob; decoding the second message including the second encryption key at the fob with the first encryption key; and encoding and decoding subsequent messages between the fob and the base station employing the second encryption key.

The method may employ as the encryption key a symmetric key based upon the time duration.

The method may employ as the encryption key a combination of a symmetric key based upon the time duration and a counter based upon a count of the messages between the first and second nodes.

As another aspect of the invention, a communication system for encoding and decoding messages between nodes comprises: at least two nodes comprising a first node and a second node, the first node being adapted to communicate with the second node over a communication channel, to mate with the second node, to determine a time duration of the mating with the second node, and to generate an encryption key based upon the time duration, the second node being adapted to communicate with the first node over the communication channel, to mate with the first node, to determine the time duration of the mating with the first node, and to generate the encryption key based upon the time duration, wherein the first and second nodes encode and decode messages therebetween over the communication channel employing the encryption key.

### BRIEF DESCRIPTION OF THE DRAWINGS

A full understanding of the invention can be gained from the following description of the preferred embodiments when read in conjunction with the accompanying drawings in which:

FIG. 1 is a block diagram of an encryption and decryption process in a counter (CTR) mode.

FIG. 2 is a block diagram of a home wellness system in accordance with the present invention.

FIGS. 3A and 3B show a fob mating with a sensor and a base station, respectively.

FIG. 4A shows an example mating activation mechanism between the fob and another component of the communication network of FIG. 2.

FIGS. 4B and 4C show other example mating activation mechanisms between a fob and a sensor in accordance with other aspects of the invention.

FIG. 5 is a flowchart showing encoding and decoding of messages between nodes, such as the fob and the base station of FIG. 2.

FIGS. 6A-6B form a sequence diagram of the encryption key exchange between the fob and the base station, and among the fob, the base station and the sensor of FIG. 2.

FIG. 7 is a sequence diagram of an encryption key exchange among the fob, the base station and the repeater of FIG. 2, in which the encryption key exchange between the fob and the base station has already happened.

FIGS. 8, 9 and 10A-10B are sequence diagrams of an encryption key exchange among the fob, the base station, the repeater and the sensor of FIG. 2, in which the encryption key exchange among the repeater, the fob and the base station has already happened.

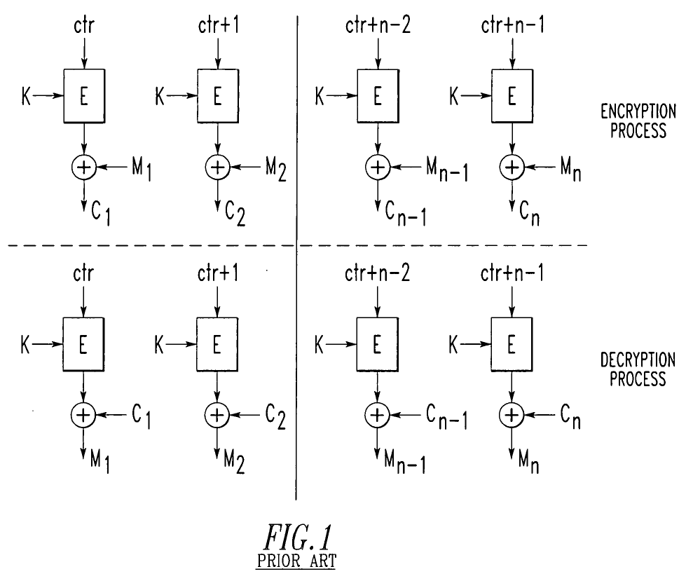

### DESCRIPTION OF THE PREFERRED EMBODIMENTS

As employed herein, the term “encoding” means encrypting, enciphering, or converting a set of intelligible information into a corresponding encrypted or cipher coded set of information.

As employed herein, the term “decoding” means decrypting, deciphering, or converting an encrypted or cipher coded set of information into a corresponding set of intelligible information.

As employed herein, the term “encryption key” means a key for encoding and/or decoding a set of intelligible information and/or a corresponding encrypted or cipher coded set of information.

As employed herein, the term “wireless” shall expressly include, but not be limited by, radio frequency (RF), infrared, wireless area networks, IEEE 802.11 (e.g., 802.11a; 802.11b; 802.11g), IEEE 802.15 (e.g., 802.15.1; 802.15.3, 802.15.4), other wireless communication standards, DECT, PWT, pager, PCS, Wi-Fi, Bluetooth™, and cellular.

As employed herein, the term “communication network” shall expressly include, but not be limited by, any local area network (LAN), wide area network (WAN), intranet, extranet, global communication network, the Internet, and/or wireless communication network.

As employed herein, the term “portable wireless communicating device” shall expressly include, but not be limited by, any portable communicating device having a wireless communication port (e.g., a portable wireless device; a portable personal computer (PC); a Personal Digital Assistant (PDA); a data phone).

As employed herein, the term “fob” shall expressly include, but not be limited by, a portable wireless communicating device; a wireless network device; an object that is directly or indirectly carried by a person; an object that is worn by a person; an object that is placed on or coupled to a household object (e.g., a refrigerator; a table); an object that is coupled to or carried by a personal object (e.g., a purse; a wallet; a credit card case); a portable object; and/or a handheld object.

As employed herein, the term “network coordinator” (NC) shall expressly include, but not be limited by, any communicating device, which operates as the coordinator for devices wanting to join a communication network and/or as a central controller in a wireless communication network.

As employed herein, the term “network device” (ND) shall expressly include, but not be limited by, any communicating device (e.g., a portable wireless communicating device; a fob; a camera/sensor device; a wireless camera; a control device; and/or a fixed wireless communicating device, such as, for example, switch sensors, motion sensors or temperature sensors as employed in a wirelessly enabled sensor network), which participates in a wireless communication network, and which is not a network coordinator.

As employed herein, the term “node” includes NDs and NCs.

As employed herein, the term “headless” means without any user input device and without any display device.

As employed herein, the term “server” shall expressly include, but not be limited by, a “headless” base station; and/or a network coordinator.

As employed herein, the term “residence” shall expressly include, but not be limited by, a home, apartment, dwelling, office and/or place where a person or persons reside(s) and/or work(s).

As employed herein, the term “home system” shall expressly include, but not be limited by, a system for a home or other type of residence.

As employed herein, a home wellness system shall expressly include, but not be limited by, a home system for monitoring and/or configuring and/or controlling aspects of a home or other type of residence.

The present invention is described in association with a wireless communication network of a home wellness system, although the invention is applicable to a wide range of communication systems, communication networks and/or communicating nodes thereof.

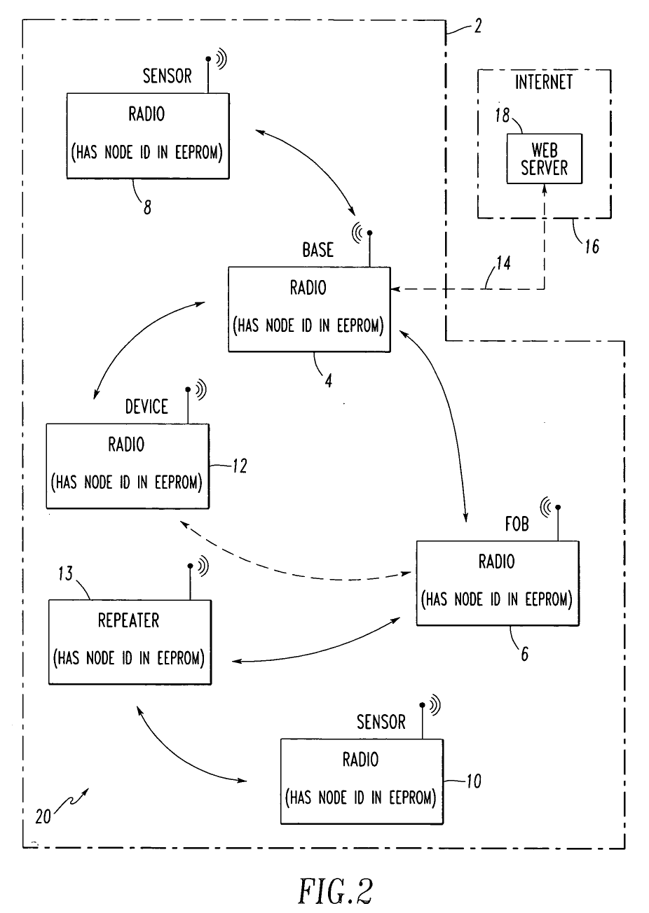

Referring to FIG. 2, a wireless home wellness system 2 is shown. The system 2 includes a “headless” RF base station 4, a portable RF fob or “house key” 6, one or more RF sensors, such as 8,10, one or more output devices, such as 12 (only one device 12 is shown in FIG. 2), and one or more repeaters, such as 13 (only one repeater 13 is shown in FIG. 2). The RF base station 4 may include a suitable link 14 (e.g., telephone; DSL; Ethernet) to the Internet 16 and, thus, to a web server 18. The sensors 8,10 may include, for example, the analog sensor 8, the on/off digital detector 10 and/or a wide range of input devices. The device 12 may include, for example, a water valve and/or a wide range of output devices. The sensors 8,10, device 12, base station 4 and fob 6 all employ relatively short distance, relatively very low power, RF communications, although the repeater 13 may be employed to repeat or forward RF communication messages from one or more nodes to one or more other nodes of the communication network 20. Some or all of these components 4,6,8,10,12,13 form a wireless network 20 in which the node ID for each of such components is unique and preferably is stored in a suitable non-volatile memory, such as EEPROM, on each such component.

The base station 4 (e.g., a wireless web server; a network coordinator) may collect data from the sensors 8,10 and “page,” or otherwise send an RF alert message to, the fob 6 in the event that a critical status changes at one or more of such sensors.

The fob 6 may be employed as both a portable in-home monitor for the various sensors 8,10 and the device 12, and also, as a portable configuration tool for the base station 4 and such sensors and such device, and, further, as a remote control for such device.

The example base station 4 is headless and includes no user interface. Alternatively, the invention is applicable to servers, such as base stations, having a local or remote user interface. The sensors 8,10 preferably include no user interface, although some sensors may have a status indicator (e.g., an LED (not shown)). The user interface functions are provided by the fob 6. As shown with the device 12, the network 20 preferably employs an adhoc, multihop capability, in which the sensors 8,10, the device 12 and the fob 6 do not have to be within range of the base station 4, in order to communicate.

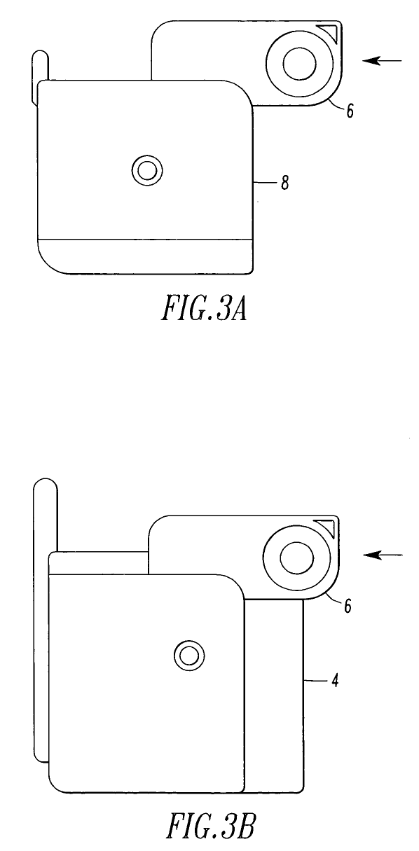

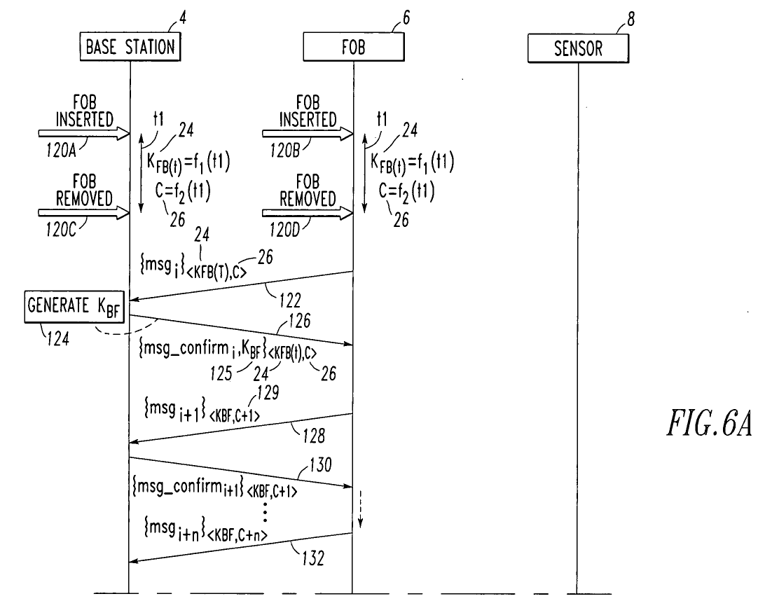

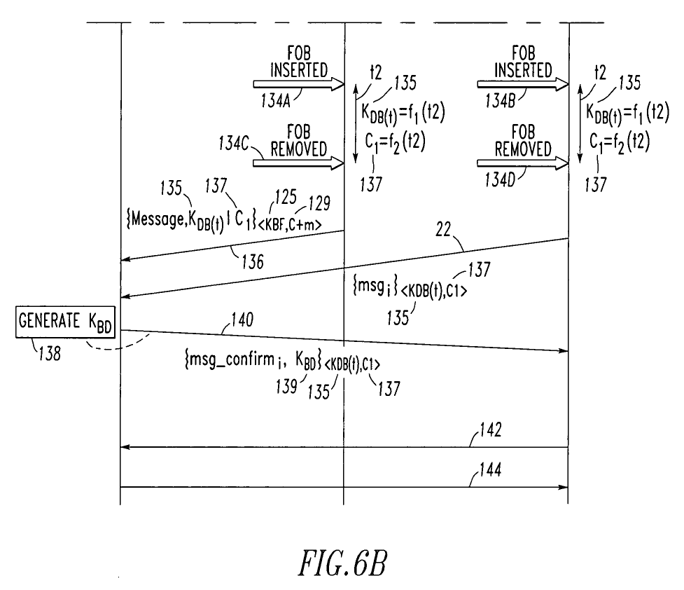

In the example communication network 20, the base station 4 is a trust center and is positioned in a suitably secure place, since (as a design decision) any node, such as 6,8,10,12,13, will get access to the communication network 20 as soon at it “pairs” to the base station 4, as will be described. This is achieved by suitable mating, such as, for example, inserting and removing the fob 6 into and from a node, such as the sensor 8 of FIG. 3A or the base station 4 of FIG. 3B. The base station 4 houses (after generation, for example, as is discussed below in connection with FIGS. 6A-6B) secret encryption keys and counter values for all nodes 6,8,10,12,13 in the communication network 20. The base station 4 does not have critical memory and/or power constraints as do some, most or all of the other nodes in the communication network 20.

FIGS. 3A and 3B show the activation mechanism of the communication network 20 of FIG. 2 through the fob 6. All nodes 6,8,10,12,13 can measure the elapsed time “Δt” of the activation process, which is the mating time, such as, for example, the time elapsed between fob 6 insertion and removal. For example, the elapsed time measurement resolution may be at least about ±50 ms. If, for example, the fob-measured elapsed time and the node-measured elapsed time are off by one count of such resolution, then the message 22 (FIG. 6B) from the node (e.g., sensor 8) to the base station 4 would not be recognized and the user would retry, as will be described. The function to generate an initial master encryption key 24 and a counter 26 employed for corresponding encoding/decoding is preferably known by all nodes 4,6,8,10,12,13 in the communication network 20, as is shown with the base station 4 and the fob 6 of FIGS. 6A-6B.

The disclosed protocol makes use of an innovative out of band signaling mechanism to initialize the encryption keys. The nodes 4,6,8,10,12,13 used in the communication network 20 are wireless nodes and the main components include the base station 4, the fob 6, the sensors 8,10, the device 12 and/or the repeater 13. The notations, as discussed below and in connection with FIGS. 6A-6B, 7-9 and 10A-10B, represent various security operations as are employed in the communication network 20.

(1) A, B are principals, such as communicating nodes.

(2) K_{AB} denotes a secret (symmetric) (e.g., 128-bit) encryption key which is shared between communicating nodes A and B.

(3) K_{DB(t)} (in this example, (t) is the same as (Δt)) denotes the initial (e.g., 128-bit) secret encryption key, which is shared between a node (D) and the base station (B) 4.

(4) K_{FB(t)} denotes the initial (e.g., 128-bit) secret encryption key, which is shared between the fob (F) 6 and the base station (B) 4.

(5) K_{BF} is the base station-generated (e.g., 128-bit) encryption key shared with the fob (F) 6. For example, hash functions may be employed in a way that no one key will compromise the system. A hash function may be employed such that the generated keys are unique.

(6) K_{BD} is the base station-generated (e.g., 128-bit) encryption key shared with the node (D).

(7) {M}_{<KAB, C>} is the encryption of message M, with the symmetric encryption key (K_{AB}) shared by nodes A and B, and a counter C, which is used in encryption modes such as, for example, cipher-block chaining (CBC mode) or counter mode (CTR mode).

(8) M1|M2 denotes the concatenation of communication messages M1 and M2.

(9) The function f(ti) is a function of time, ti, which function generates the encryption key or counter based on a suitable hash function, such as a hash table residing in the node.

First, the fob 6 joins the communication network 20 (FIG. 2) by being mated with (e.g., inserted in and removed from) the base station 4 as shown in FIG. 3B. This process normally takes more than several seconds in duration. Since only the two nodes, such as 4,6, that mated (e.g., came into physical contact or close proximity with each other) will know the time elapsed of that mating (e.g., time KEY_FOB_REMOVED—time KEY_FOB_INSERTED), this time difference may be employed to generate an encryption key based on a commonly known function by the two nodes. Thus, the encryption key generated is the same (excluding any rounding error as was discussed, above) in both nodes 4,6.

### EXAMPLE 1

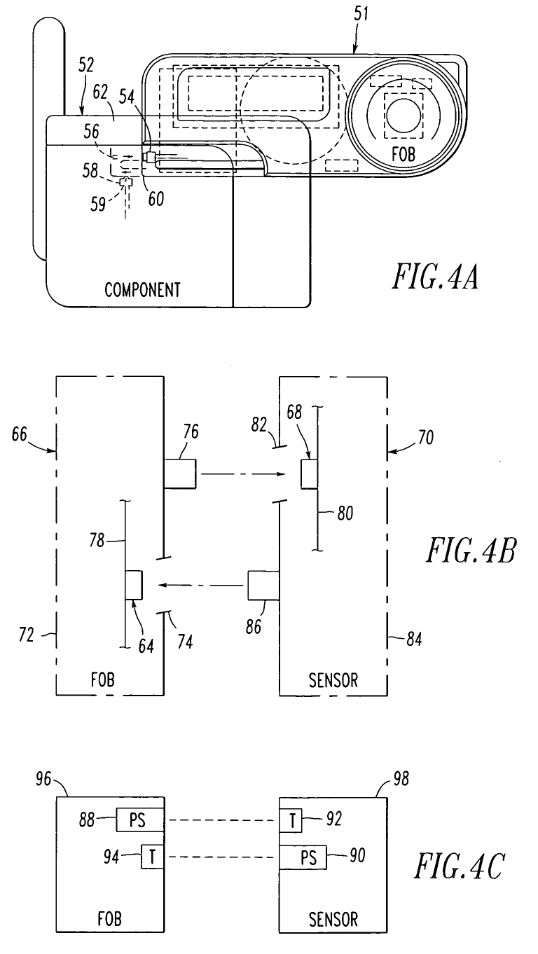

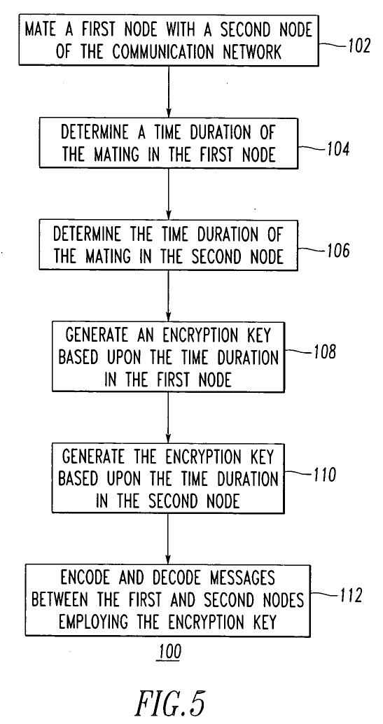

FIG. 4A shows an example of another fob 51, which may be the same as or similar to the fob 6 of FIG. 2, and a wireless system component 52 (e.g., a sensor 8,10; a base station 4; a device 12; a repeater 13), which are suitably mated for configuration of the system component 52 and/or the fob 51. The fob 51 includes a training/mating switch 54. The component 52 includes a surface or protrusion 56, which is designed to engage the switch 54. The component 52 also includes a training/mating switch 58 having an actuator 59. The fob 51 includes a protrusion or surface 60, which is designed to engage the switch actuator 59. Initially, the fob 51 is slid into the component 52. For example, the fob 51 includes an engagement portion (not shown) having a tongue (not shown), while the component 52 has a corresponding mating engagement recess (not shown) with a corresponding groove (not shown). As the component protrusion 56 approaches the fob switch 54, it engages and activates an actuator 62 thereon. At the same time, as the fob surface 60 approaches the component switch actuator 59, it engages and activates that actuator 59. In turn, when the fob 51 and component 52 are completely seated, with both switches 54,58 being activated, the fob 51 and component 52 may establish RF communications with the base station 4 of FIG. 2. In this example, the component switch 58 is activated and deactivated preferably at about the same respective times as of the fob switch 54. Also, in the example, the component switch 58 may be a two-pole device, which is designed to detect both insertion and removal of the fob 51.

### EXAMPLE 2

FIG. 4B shows an example of the sensor/base/device program switch 64 of a fob 66, and the sensor program switch 68 of a sensor 70. The fob 66 includes a case or enclosure 72 having an opening 74, a protrusion 76 and a printed circuit board 78 therein. The sensor/base/device program switch 64 is proximate the opening 74, and the sensor program switch 68 is on a printed circuit board 80 and proximate the opening 82 of the sensor case or enclosure 84. Whenever the fob 66 is suitably mated with the sensor 70, the fob protrusion 76 passes through the sensor opening 82 and engages the sensor program switch 68. At the same time, whenever the sensor 70 is suitably mated with the fob 66, the sensor protrusion 86 passes through the fob opening 74 and engages the sensor/base/device program switch 64.

### EXAMPLE 3

As an alternative to the switches 64,68 and protrusions 76,86 of FIG. 4B, suitable proximity sensors (PS) 88,90 and targets (T) 92,94 may be employed as shown with the two nodes 96,98 of FIG. 4C. For example, the proximity sensors 88,90 are activated and deactivated whenever the node 96 is respectively suitably proximate to and distal from the node 98.

FIG. 5 shows an example sequence of events 100 employed to encode and decode messages between nodes, such as, for example, the fob 6 and the base station 4 of the communication network 20 of FIG. 2. First, at 102, a first node, such as the fob 6, is mated with a second node, such as the base station 4. Then, at 104, a time duration of the mating is determined in the first node and, at 106, the (same) time duration of the mating is determined in the second node. Next, at 108, an encryption key is generated based upon the time duration in the first node. Then, at 110, the (same) encryption key is generated based upon the (same) time duration in the second node. Finally, at 112, the two nodes encode and decode messages therebetween employing the common encryption key.

FIGS. 6A-6B show a sequence of communication messages for encryption key exchange between the fob 6 and the base station 4, and among the fob 6, the base station 4 and the sensor 8 of FIG. 2. First, between 120A-120C and 120B-120D, when the fob 6 mates with the base station 4, the initial master key (K_{FB(t)}) 24 and the counter (C) 26 are determined about simultaneously between the two nodes 4,6, based upon the mating time duration, which, in this example, is time t1. The fob 6 sends a profile (i.e., an initial identification) message ({msgᵢ}) 122 encrypted by K_{FB(t)} 24 and C 26 as a wireless communication message to the base station 4. The base station 4 decrypts this message and generates, at 124, a second encryption key (K_{BF}) (e.g., generated by a suitable hash function; generated in the manner set forth in http://www.burtleburtle.net/bob/hash/examhash.html) that is sent as a payload 125 of the profile confirm message ({msg_confirmᵢ}) 126, which is encrypted by K_{FB(t)} 24 and C 26. The fob 6 obtains K_{BF} 125 and employs this encryption key (in combination with the counter, C 26, which is incremented by the fob 6 to C+1) for any future communication (e.g., {msgᵢ₊₁} 128; {msg_confirmᵢ₊₁} 130) (as shown in FIG. 6A). Here, the selected key (K_{BF}) 125 along with the counter 129 (e.g., C+1) are employed for the CTR mode of Advanced Encryption Standard (AES) encryption. To maintain the freshness of messages, such as 122,128,132, the counter 129 is incremented (e.g., to C+2; C+3; C+4; . . . ; C+n) with every successfully transmitted message including {msg_confirmᵢ₊₁} 130 as shown in FIG. 6A.

Later, the fob 6 activates a node, such as the sensor 8, via a suitable mating action, between 134A-134C and 134B-134D. Then, based upon the mating time duration, which, in this example, is time t2, an initial Master encryption key (K_{DB(t)}) 135 and a counter C₁ 137 are determined about simultaneously between the two nodes 6,8. The node 8 sends the profile (i.e., initial identification) message {msgᵢ} 22 encrypted by K_{DB(t)} 135 and C₁ 137 as a wireless message to the base station 4. At about the same time, the fob 6 sends K_{DB(t)} 135 and C₁ 137 to the base station 4 encrypted by the already known K_{BF} 125 and counter C 129 (e.g., which in this example, has been incremented to C+m). With these two profile messages 22,136, the base station 4 decrypts the node message 22 and generates a second key (K_{BD}) at 138 that will be sent as a payload 139 of the profile confirm message {msg_confirmᵢ} 140 as encrypted by K_{DB(t)} 135 and C₁ 137. The sensor 8 then obtains K_{BD} 139 and employs this encryption key (in combination with the counter C₁ 137) for any future communication. For example, the sensor 8 and base station 4 employ K_{BD} 139 and the counter C₁ 137 to encrypt and decrypt subsequent communication messages, such as 142,144, therebetween.

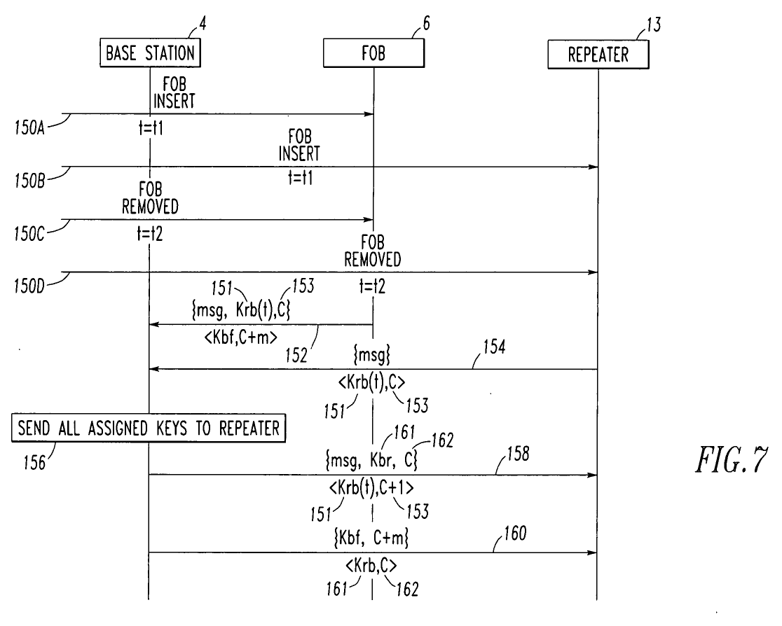

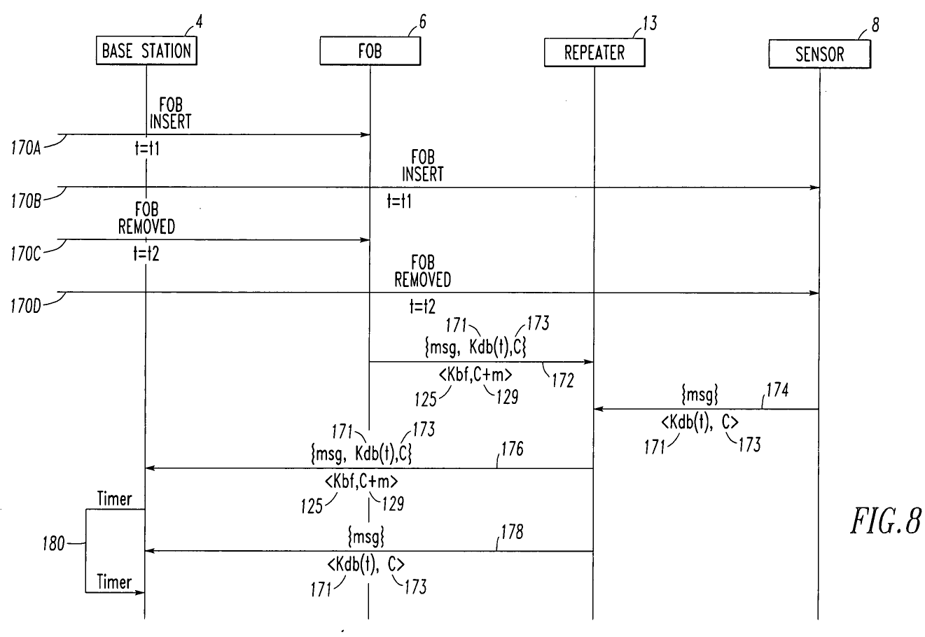

If the repeater 13 (FIG. 2) is present in the communication network 20, as is discussed, below, in connection with FIGS. 7-9 and 10A-10B, then an encryption key is established between the base station 4 and the repeater 13. In the same way as any other node, this encryption key is employed to encrypt the encryption keys that the repeater 13 needs to possess for communicating with other nodes 6,8,10,12.

FIG. 7 shows the user activating the repeater 13 using the fob 6 at 150A-150C and 150B-150D after the encryption key exchange between the fob 6 and the base station 4 (FIG. 6A) has already happened. First, the fob 6 and the repeater 13 update the base station 4 with the encryption key based upon the time difference (e.g., Δt=t2−t1 in this example) between the insertion time (e.g., t1 in this example) and the removal time (e.g., t2 in this example) of the fob 6 at the repeater 13. Both the fob 6 and the repeater 13 generate an encryption key 151 and a counter C 153 used for communication based on this time difference (Δt). For example, both employ a suitable hash function (e.g., Krb(t)=f(t2,t1)). The fob 6 sends communication message {msg, Krb(t) 151, C 153 } 152 encrypted by <Kbf,C+m> (FIG. 7) and the repeater 13 sends communication message {msg} 154 encrypted by <Krb(t),C>. Next, at 156, the base station 4 sends all assigned encryption keys for every node in the communication network 20 (FIG. 2) to the repeater 13. First, the base station 4 sends communication message {msg, Kbr, C} 158 encrypted by <Krb(t), C+1>to the repeater 13, in order to provide the new encryption key (Kbr) 161 and new counter (C) 162 to the repeater 13. Then, the base station 4 sends communication message {Kbf, C+m} 160 encrypted by <Kbr 161, C 162>, in order to provide the encryption key (Kbf) and counter (C+m) of the fob 6 to the repeater 13. The repeater 13 acts as a secondary trust center and has an encryption key repository, in order to receive and forward messages, although it cannot distribute the encryption keys.

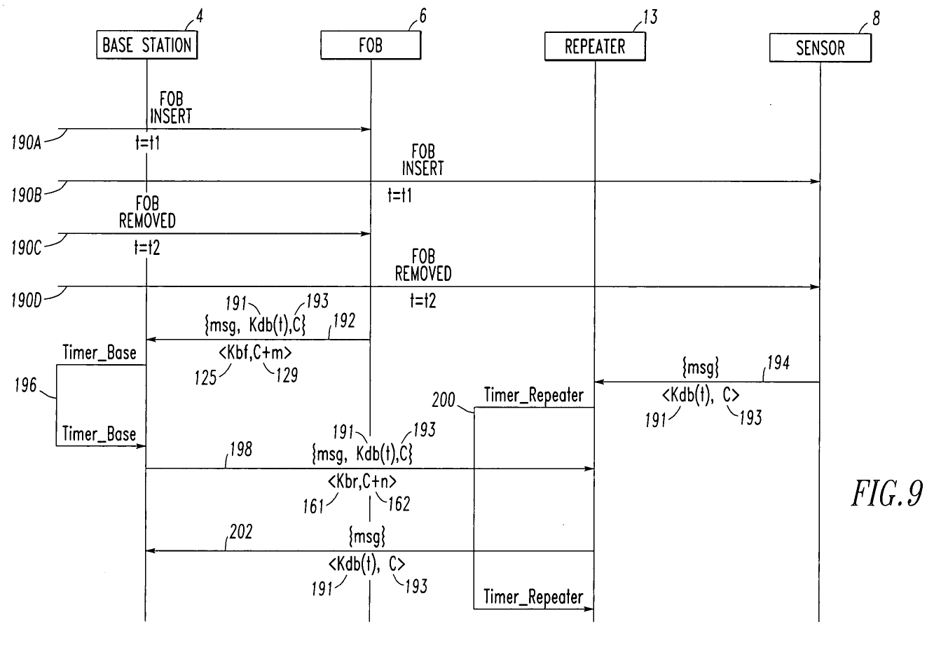

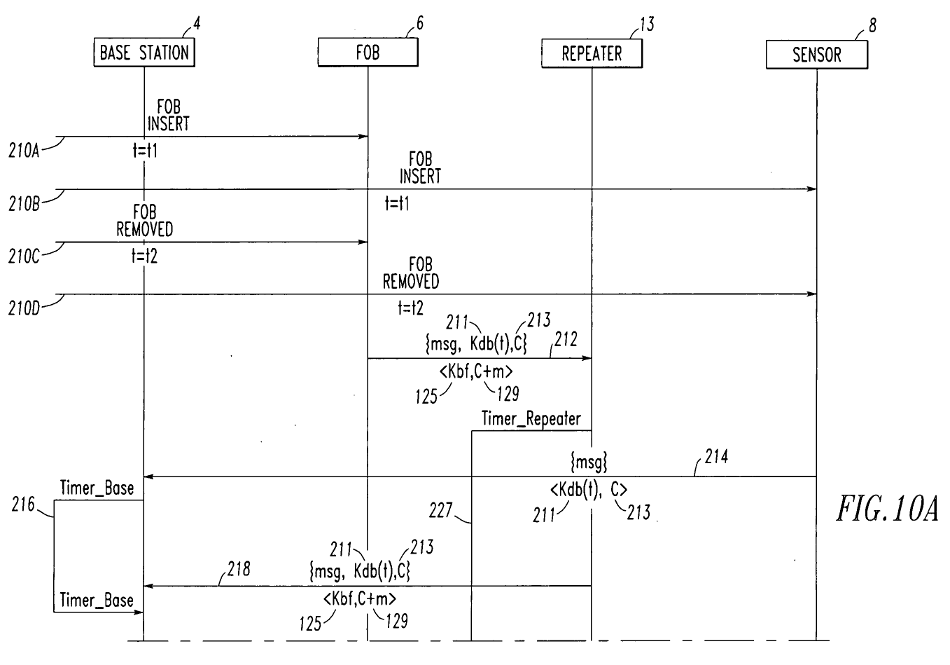

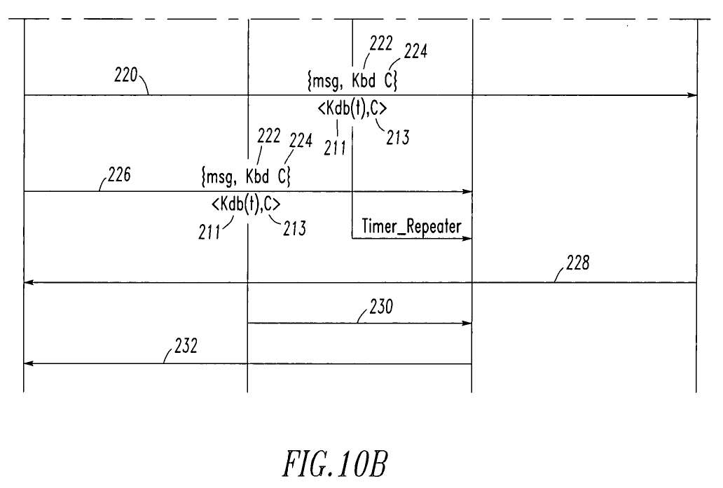

In FIG. 8, both the fob 6 and the sensor 8 talk through the repeater 13 to the base station 4. Thus, they send their messages to the repeater 13 encrypted by their respective keys. In FIG. 9, the fob 6 can talk to the base station 4 directly, but the sensor 8 has to communicate through the repeater 13. In this scenario, the timer 200 started by the repeater 13 helps to keep track of the messages received from the sensor 8 and the corresponding fob 6. In FIGS. 10A-10B, the fob 6 talks through the repeater 13 and the sensor 8 communicates directly to the base station 4. In this scenario, the fob's key has to be known by the repeater 13 and, thus, it uses Kbf.

FIG. 8 shows the user activating the sensor 8 using the fob 6 at 170A- 170C and 170B- 170D after the encryption key exchange among the fob 6, the base station 4 and the repeater 13 (FIG. 7) has already happened. First, the fob 6 and the sensor 8 update the base station 4 based upon the time difference (e.g., Δt=t2−t1 in this example) between the insertion time (e.g., t1 in this example) and the removal time (e.g., t2 in this example) of the fob 6 at the sensor 8. Both the fob 6 and the sensor 8 generate an encryption key 171 and a counter (C) 173 used for communication based on this time difference (Δt). For example, a suitable hash function (e.g., Kdb(t)=f(t2,t1)) determines the encryption key used for communication based upon this time difference (Δt). Since, in this example, unlike the example of FIGS. 6A-6B, the sensor 8 and the fob 6 are relatively further away from the base station 4, the relatively closer repeater 13 acts as a routing node. Since, the repeater 13 has the encryption keys used in the communication network 20, it can read the traffic in the communication network 20, such as the fob communication message 172 and the sensor communication message 174.

The repeater 13 acts as a forwarding agent, but it needs to make sure that it is not forwarding “spoofed” messages. Thus, it makes use of the knowledge it has to check the integrity of the messages using the encryption keys of different devices in the network 20. Here, integrity refers to a “Message Integrity Check” or message authentication code (MAC), as is discussed below, that is added to every message in the network 20.

The fob 6 sends communication message {msg, Kdb(t) 171, C 173} 172 encrypted by <Kbf 125, C+m 129> to the repeater 13, in order to provide the encryption key (Kdb(t) 171) and counter (C 173) to the repeater 13. Then, the sensor 8 sends profile communication message {msg} 174 encrypted by <Kdb(t) 171, C 173>, in order to provide the profile of the sensor 8 to the base station 4 through the repeater 13. Finally, the repeater 13 forwards the messages 172,174 as respective communication messages 176,178 to the base station 4. The first message 176 provides the sensor encryption key Kdb(t) 171 and sensor counter C 173 to the base station 4, in order to decrypt the message 178. Preferably, the base station 4 employs a suitable timer (Timer) 180, to ensure that the messages 176,178 are both received within a suitable time of each other. In turn, as was discussed at 138 of FIG. 6B, based upon the two messages 176,178, the base station 4 decrypts the sensor message 178 and generates a second key (K_{BD} 138) (FIG. 6B) that will be sent as a payload (not shown) of a profile confirm message {msg_confirmᵢ} (not shown) as encrypted by Kdb(t) 171 and C 173. The sensor 8 then obtains K_{BD} and employs this encryption key (in combination with the counter C 173) for any future communication.

FIG. 9 shows the user activating the sensor 8 using the fob 6 at 190A-190C and 190B-190D after the encryption key exchange among the fob 6, the base station 4 and the repeater 13 (FIG. 7) has already happened. First, the fob 6 and the sensor 8 update the base station 4 based upon the time difference (e.g., Δt=t2−t1 in this example) between the insertion time (e.g., t1 in this example) and the removal time (e.g., t2 in this example) of the fob 6 at the sensor 8. Both the fob 6 and the sensor 8 generate an encryption key 191 used for communication based on this time difference (Δt). For example, a suitable hash function (e.g., Kdb(t)=f(t2,t1)) determines the encryption key used for communication based upon this time difference (Δt). Since, in this example, unlike the example of FIGS. 6A-6B, the sensor 8 is relatively further away from the base station 4, the relatively closer repeater 13 acts as a routing node. The fob 6 sends communication message {msg, Kdb(t) 191, C 193} 192 encrypted by <Kbf 125,C+m 129> to the base station 4. The base station 4 starts a timer (Timer_Base) 196 when it receives the message 192 from the fob 6. This timer 196 is to wait a suitable time for a communication from the sensor 8 to the repeater 13 before sending a message 198 to the repeater 13. As shown, upon expiry of this timer 196, the base station 4 sends the repeater 13 the time-base encryption key 191 as generated by the fob 6. This message 198 includes {msg, Kdb(t) 191, C 193} encrypted by <Kbr 161, C+n 162>. In this example, the fob 6 talks to the base station 4 independently of the repeater 13, while the sensor 8 has to talk to the base station 4 through the repeater 13. In this scenario, the repeater 13 gets a message 194 from the sensor 8 that cannot be decrypted since the node (e.g., sensor 8) encryption key has not yet been communicated to the repeater 13. The fob 6 does not send the encryption key in plaintext to the repeater 13. Finally, the repeater 13 starts a timer (Timer_Repeater) 200 after it receives the message 194 from the sensor 8, which indicates the time to wait before discarding that packet. This time is based on, for example, empirical measurements. However, before the time out, in this example, the repeater 13 receives the message 198 and responsively sends the message {msg} 202 from the sensor 8 as encrypted by <Kdb(t) 191, C 193> to the base station 4.

Here, the repeater 13 does not simply “forward” the message 194 as message 202. Instead, the repeater 13 employs the key 191 and the counter 193 to decode and read the message 194. The rationale is that the sensor message 194 needs to be validated before it can be forwarded to the base station 4 for this application. Thus, the repeater 13 waits for the key 191 from the base station 4 and then checks the message integrity before forwarding the message 202 to the base station 4.

FIGS. 10A-10B show the user activating the sensor 8 using the fob 6 at 210A-210C and 210B-210D after the encryption key exchange among the fob 6, the base station 4 and the repeater 13 (FIG. 7) has already happened. First, the fob 6 and the sensor 8 update the base station 4 based upon the time difference (e.g., Δt=t2−t1 in this example) between the insertion time (e.g., t1 in this example) and the removal time (e.g., t2 in this example) of the fob 6 at the sensor 8. Both the fob 6 and the sensor 8 generate an encryption key 211 and a counter 213 used for communication based on this time difference (Δt). For example, a suitable hash function (e.g., Kdb(t)=f(t2,t1)) determines the encryption key used for communication based upon this time difference (Δt). Since, in this example, unlike the example of FIGS. 6A-6B, the fob 6 is relatively further away (for convenience of illustration, FIGS. 10A-10B do not show relative physical positions) from the base station 4, the relatively closer repeater 13 acts as a routing node. The fob 6 seeks to send communication message {msg, Kdb(t) 211, C 213} 212 encrypted by <Kbf 125,C+m 129> to the base station 4. In this example, the sensor 8 talks to the base station 4 independently of the repeater 13, while the fob 6 has to talk to the base station 4 through the repeater 13. The sensor 8 sends profile communication message {msg} 214 encrypted by <Kdb(t) 211, C 213>, in order to provide the profile of the sensor 8 to the base station 4. In response, the base station 4 starts a timer (Timer_Base) 216 when it receives the message 214 from the sensor 8. This timer 216 is to wait for a communication (e.g., message 218) from the fob 6 through the repeater 13. Upon expiry of this timer, the base station 4 will send an encryption key generated for the sensor 8 and the time-based key to the repeater 13.

In this scenario, the repeater 13 gets the message 212 from the fob 6 and sees that this message is for the base station 4, validates the message 212 through the integrity check (since the symmetric key 125 for the fob 6 is known by the repeater 13) and forwards it as the message 218 to the base station 4, which waits for any communication from the fob 6. For example, a MAC provides a method of performing a checksum on the message with the key, thereby making it secure. The MAC or Message Integrity Check is not encrypted, and the recipient does not have to decrypt it. In response, the base station 4 sends communication message {msg, Kbd 222, C 224} 220 to the sensor 8 including a new encryption key Kbd 222 and counter C 224 encrypted by <Kdb(t) 211,C 213> and, also, sends communication message {msg, Kbd 222, C 224} 226 encrypted by <Kdb(t) 211,C 213> to the repeater 13. Here, the repeater 13 employs a timer (Timer_Repeater) 227 after receiving the message 212 within which time the message 226 must be received. Subsequently, the fob 6, sensor 8, repeater 13 and base station 4 employ Kbd 222 and the counter C 224 to encrypt and decrypt subsequent communication messages, such as 228,230,232.

### EXAMPLE 4

The disclosed mating and activation procedures are done without any user intervention other than the initial fob/node mating used to register the node 6,8,10,12,13 to the communication network 20. The secure key exchange along with the crypto engine (e.g., a suitable hash function), which generates the encryption keys and counters, offers the following advantages to the communication network 20. First, there is Semantic Security, since the counter value (C) is incremented after each communication message and, hence, the same message is encrypted differently each time. For example, in FIG. 7, the messages 154 and 158 are different, in that the payload in message 154 just has the information regarding the new device that is trying to register. In message 158, the base station 4 sends the same payload with the key it has generated for that device to communicate with the base station. In message 154, the counter is set to C, in message 158 the counter is set to C+1, thus the key used in message 158 would have changed, implying the encrypted message (even if the same data is being transmitted) would appear different for an eavesdropper.

Next, there is Confidentiality since only the two nodes, which were mated for the “Symmetric Key, Key Exchange” (SKKE) based protocol, share the initial master key and counter. The link encryption key is generated from the master encryption key and is sent to the node 6,8,10,12,13 by the base station 4 in encrypted form. Hence, there is no plaintext transferred through the insecure wireless medium and, thus, there is adequate confidentiality provided in this security mechanism.

Next, there is Replay protection since the counter value in the encryption prevents replaying old messages. If the counter were not present, then a malicious node could replay messages.

There is also Masquerade protection since the nodes are protected against masquerading. A malicious node cannot obtain the encryption keys that were initialized between the two nodes that were mated.

In the event that a malicious node guessed the initial master key, it would not be able to decrypt the data, since link keys are employed that were generated by the base station 4.

There is also Denial of Service attack (DOS) prevention since the probability of a DOS attack is reduced due to the Replay protection and Masquerade protection that is offered by the disclosed key exchange mechanism. The possibility of exhausting the battery power of a node and, in turn, leading to a DOS attack is prevented as the crypto engine rejects messages with an incorrect message authentication code (MAC). MAC is a form of integrity check performed on the messages without spending the power and energy to decrypt the message. MAC checks the validation of the message based on the key used. Each outgoing message is attached with a MAC, which is similar to the CRC checksum at lower layers. The MAC is computed based on the data and the key used. Any intended destination verifies the MAC by doing an XOR of the key and the ciphertext. If it returns a non-zero value, then the message has been modified enroute and the integrity of the message fails.

Next, there is a low communication overhead since there is very little communication overhead involved in this key exchange mechanism, due to the fact that the encryption keys are chosen based on the fob/node mating physical activation procedure.

Finally, there is no user intervention for securing the system, since there are no additional steps apart from the initial mating procedure. This provides a seamless and low-cost procedure whereby the user does not need to enter a password and, thus, is not involved in the secure encryption key exchange.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A method of encoding and decoding messages between nodes of a communication network, said method comprising:
mating a first node with a second node of said communication network;
determining a time duration of said mating in the first node;
determining the time duration of said mating in the second node;
generating an encryption key based upon said time duration in the first node;
generating the encryption key based upon said time duration in the second node; and
encoding and decoding messages between said first and second nodes employing said encryption key.

2. The method of claim 1 further comprising
employing as said mating mechanically engaging said first and second nodes.

3. The method of claim 1 further comprising
employing as said mating positioning said first node proximate said second node.

4. The method of claim 1 further comprising
employing as said first node a fob;
employing as said second node a base station; and
mating said fob with said base station.

5. The method of claim 4 further comprising
employing as said encryption key a first encryption key;
encoding a first message at said fob with said first encryption key;
sending said first message from said fob to said base station;
decoding said first message at said base station with said first encryption key;
generating a second encryption key at said base station;
encoding a second message including said second encryption key at said base station with said first encryption key;
sending said second message including said second encryption key from said base station to said fob;
decoding said second message including said second encryption key at said fob with said first encryption key; and
encoding and decoding subsequent messages between said fob and said base station employing said second encryption key.

6. The method of claim 4 further comprising
employing a third node of said communication network;
mating said fob with said third node.

7. The method of claim 6 further comprising
employing as said encryption key a first encryption key;
employing as said time duration a first time duration;
determining a second time duration of said mating said fob with said third node in said third node;
determining the second time duration of said mating said fob with said third node in said fob;
generating a second encryption key based upon said second time duration in said third node;
generating the second encryption key based upon said second time duration in said fob;
encoding a first message including said second encryption key at said fob with said first encryption key;
sending said first message including said second encryption key from said fob to said base station;
decoding said first message including said second encryption key at said base station with said first encryption key;
encoding a second message at said third node with said second encryption key;
sending said second message from said third node to said base station; and
decoding said second message at said base station with said second encryption key.

8. The method of claim 7 further comprising
generating a third encryption key at said base station;
encoding a third message including said third encryption key at said base station with said second encryption key;
sending said third message from said base station to said third node;
decoding said third message at said third node with said second encryption key; and
encoding and decoding subsequent messages between said third node and said base station employing said third encryption key.

9. The method of claim 6 further comprising
employing as said third node one of a sensor, a device and a repeater.

10. The method of claim 1 further comprising
employing as said encryption key a symmetric key based upon said time duration.

11. The method of claim 1 further comprising
employing as said encryption key a combination of a symmetric key based upon said time duration and a counter based upon a count of said messages between said first and second nodes.

12. The method of claim 11 further comprising
incrementing said counter for each successfully transmitted one of said messages between said first and second nodes.

13. The method of claim 1 further comprising
employing as said encoding and decoding one of a CBC mode and a CTR mode.

14. The method of claim 5 further comprising
sending as said first message from said fob to said base station a profile message; and
employing as said second message from said base station to said fob a profile confirm message having a payload including said second encryption key.

15. The method of claim 8 further comprising
employing as said second message from said third node to said base station a profile message.

16. The method of claim 15 further comprising
employing as said third message from said base station to said third node a profile confirm message having a payload including said third encryption key.

17. The method of claim 7 further comprising
employing a repeater as said third node;
mating said fob with said repeater;
establishing a unique encryption key between said base station and said repeater; and
encoding and decoding a message between said repeater and said base station employing said unique encryption key.

18. The method of claim 17 further comprising
sending at least one additional unique encryption key from said base station to said repeater employing said unique encryption key for encoding and decoding messages therebetween.

19. The method of claim 18 further comprising
employing as said at least one additional unique encryption key a plurality of additional unique encryption keys;
employing a fourth node in said communication network associated with one of said additional unique encryption keys; and
routing a message from said fourth node through said repeater to said base station employing said one of said additional unique encryption keys.

20. The method of claim 17 further comprising
employing a fourth node in said communication network;
mating said fob with said fourth node;
determining a second time duration of said mating said fob with said fourth node in said fourth node;
determining the second time duration of said mating said fob with said fourth node in said fob;
generating a third encryption key based upon said second time duration in said fourth node;
generating the third encryption key based upon said second time duration in said fob;
encoding a third message including said third encryption key at said fob with said first encryption key;
sending said third message including said third encryption key from said fob to said base station;
decoding said third message including said third encryption key at said base station with said first encryption key;
encoding a fourth message at said fourth node with said third encryption key;
sending said fourth message from said fourth node to said repeater;
sending a fifth message including said third encryption key from base station to said repeater;
validating said fifth message including said third encryption key at said repeater with said second encryption key;
encoding said fourth message at said repeater with said third encryption key;
sending said fourth message from said repeater to said base station; and
decoding said fourth message at said base station with said third encryption key.

21. The method of claim 17 further comprising
employing a fourth node in said communication network;
mating said fob with said fourth node;
determining a second time duration of said mating said fob with said fourth node in said fourth node;
determining the second time duration of said mating said fob with said fourth node in said fob;
generating a third encryption key based upon said second time duration in said fourth node;
generating the third encryption key based upon said second time duration in said fob;
encoding a third message including said third encryption key at said fob with said first encryption key;
sending said third message including said third encryption key from said fob to said repeater;
encoding a fourth message at said fourth node with said third encryption key;
sending said fourth message from said fourth node to said base station;
sending said third message including said third encryption key from said repeater to said base station;
generating a fourth encryption key at said base station;
encoding a fifth message including said fourth encryption key at said base station with said third encryption key;
sending said fifth message including said fourth encryption key from said base station to said repeater;
validating said fifth message at said repeater with said third encryption key;
sending said fifth message including said fourth encryption key from said base station to said fourth node;
decoding said fifth message at said fourth node with said third encryption key; and
encoding and decoding subsequent messages between said fourth node, said repeater and said base station employing said fourth encryption key.

22. The method of claim 1 further comprising
employing as said communication network a wireless communication network.

23. The method of claim 1 further comprising
employing a hash function in said first and second nodes to generate said encryption key based upon said time duration.

24. A communication system for encoding and decoding messages between nodes, said communication system comprising:
at least two nodes comprising a first node and a second node, said first node being adapted to communicate with said second node over a communication channel, to mate with said second node, to determine a time duration of said mating with said second node, and to generate an encryption key based upon said time duration, said second node being adapted to communicate with said first node over said communication channel, to mate with said first node, to determine the time duration of said mating with said first node, and to generate said encryption key based upon said time duration,
wherein said first and second nodes encode and decode messages therebetween over said communication channel employing said encryption key.
